(19) United States
(12) Patent Application Publication
(10) Pub. No.: US 2013/0013092 A1
(43) Pub. Date: Jan. 10, 2013

(54) FANTASY SPORTS TRADE DEBATE SYSTEMS

(76) Inventors: Johan Lang, New York, NY (US); William Strobel, New York, NY (US); Matt Karlitz, Ardsley, NY (US)

(21) Appl. No.: 13/367,637

(22) Filed: Feb. 7, 2012

Related U.S. Application Data
(60) Provisional application No. 61/505,556, filed on Jul. 8, 2011.

(51) Int. Cl. G06F 19/00

(52) U.S. Cl. 700/91

(57) ABSTRACT

A fantasy sports trade evaluation and advisory system comprising a trade debate website hosted on a computer server comprising a central database. Fantasy team managers participating in a variety of fantasy sports leagues may freely register an account on the trade debate website and may post a fantasy sports trade for other users to review and vote on via an online poll. The poll may comprise options for voting for either manager who the website user believes to be receiving the benefit of the bargain along with an option for indicating that the trade is perceived to be even. The results may be posted for the website user to see once the vote has been placed. The fantasy sports trade evaluation and advisory system may provide a social, online, global community for fantasy sports competitors of all fantasy sports types and leagues.

### CROSS-REFERENCE TO RELATED APPLICATION

The present application is related to and claims priority from prior provisional application Ser. No. 61/505,556, filed Jul. 8, 2011 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of fantasy sports and more specifically relates to an internet-based membership community (system) for voting and assessing the trading of fantasy players between fantasy sports team managers.

### 2. DESCRIPTION OF THE RELATED ART

Many people join various fantasy sports leagues in which they manage teams and players. Some of these individuals join high-stake leagues in which they spend a lot of money to be in the league. Other sports enthusiasts join fantasy leagues for fun and enjoy drafting players, trading players, and managing a fantasy team. No matter the league, most players want to win and often search for information and statistics online for guidance on what to do. These statistics are typically generated by calculating numbers and often times do not reflect the personal aspect of any given situation. This information may be available online, but there may not be one, contained site in which this information is provided. Further, statistics may be out of date by the time an individual receives them, thus rendering the information useless. An informative, helpful and reliable solution is desired by such individuals.

Various attempts have been made to solve the above-mentioned problems such as those found in U.S. Publication Nos. 2002/0065097 to Brockenbrough et al; 2003/0054885 to Pinto et al; 2011/0237317 to Noonan et al; 2010/0075729 to Allen et al; 2008/0096594 to Vinding; and 2007/0233585 to Simon et al. This prior art is representative of fantasy sports advisory communities. None of the above inventions and patents, taken either singly or in combination, is seen to describe the invention as claimed.

Ideally, an online fantasy sports trade advisory community should assess a fantasy player's value in an open market by enabling fantasy team managers to provide real time input on actual trades, such trades are publicly viewable and votable, and whereby such trades are updated on an internet based website in real time. Thus, a need exists for a fantasy sports trade debate system to provide an internet-based community website for fantasy manager's to receive up-to-date information as to the current value of particular fantasy players and to avoid the above-mentioned problems.

### BRIEF SUMMARY OF THE INVENTION

In view of the foregoing disadvantages inherent in the known fantasy sports art, the present invention provides a novel fantasy sports trade debate, evaluation, and peer advisory system. The general purpose of the present invention, which will be described subsequently in greater detail, is to provide an internet-based fantasy sports community for providing user-supplied information concerning the value of fantasy players in a fantasy sports league.

Fantasy sports trade debate systems as disclosed herein in a preferred embodiment may comprise an internet-based website that may provide fantasy sports participants with advice on how to manage their fantasy sports teams in a social media setting. More specifically, a fantasy sports trade debate website may assist players in the decision-making process about trades, evaluation of players, and other related issues. The website may be driven by user-generated polls, rating systems, comments, and recommendations. By using this website, fantasy sports team managers may rely on the advice and assertions of others, rather than statistical data that may only show one side of a situation. Fantasy sports trade debate systems may provide fantasy sports players with a helpful and informative platform to which fantasy sports team managers may go for advice and updates from fellow players.

The trade debate website of fantasy sports trade debate systems may be hosted on a secure computer server and may further comprise a central database. The central database may collect user information from website visitors such that a website visitor may register a free account. Once registered, the user may be able to securely log in with a unique username and password. The user may then create a new trade by configuring trade parameters. The trade parameters may include options for indicating the type of fantasy league, sub-type of league, how many teams are in the league, and a full player list of players who are actively playing in that particular type of league. The user may select the players to be traded to each fantasy team manager. Further, the user may insert user-defined comments and notes that may assist other website users in evaluating the merits of the trade. Once the trade parameters are configured, the user may publish the trade to the trade debate website such that other users may comment and vote on the trade.

When a website user votes on a published trade, the user will be able to view the voting results. However, the user will not be able to view the results of the trade until a vote has been placed. This may serve as an incentive to the user to contribute his or her input on the trade which may drive the success of the website. The website user who wishes to vote on the trade may vote for either Manager A, Manager B, or vote that the trade is even and fair. On the voting results page, the user will then be able to see a bar graph indicating which side has received more votes and may then base their own personal decisions on managing their fantasy team accordingly.

The trade debate website is designed to be socially friendly and easy-to-navigate. The central database may further comprise a plurality of RSS feeds. The RSS feeds may syndicate website news and updates, along with player reports, injury reports, and other important sporting league information relevant to fantasy sports. Social media and print and share icons may be present on each trade screen such that each individual trade may be easily shared via popular social media websites, as well as printed for personal reference or shared via email to other individuals.

The present invention holds significant improvements and serves as a fantasy sports trade debate system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, fantasy sports trade debate system, constructed and operative according to the teachings of the present invention

FIGS. 1A, 1B, and 1C show a perspective view illustrating a fantasy sports trade debate system (fantasy sports trade evaluation and advisory system) in use according to an embodiment of the present invention.

FIG. 2 is a perspective view illustrating a data flowchart of the fantasy sports trade evaluation and advisory system according to an embodiment of the present invention of FIG. 1.

FIG. 3 is a perspective view illustrating a user flowchart of the fantasy sports trade evaluation and advisory system according to an embodiment of the present invention of FIG. 1.

FIG. 4 is a perspective view illustrating a new trade creator screen of a trade debate website according to an embodiment of the present invention of FIG. 1.

FIG. 5 is a perspective view illustrating a trade vote screen of the trade debate website according to an embodiment of the present invention of FIGS. 1 and 4.

FIG. 6 is a perspective view illustrating a vote results screen of the trade debate website according to an embodiment of the present invention of FIGS. 1, 4 and 5.

FIG. 7 is a flowchart illustrating a method of use according to an embodiment of the present invention of FIGS. 1-6.

The various embodiments of the present invention will hereinafter be described in conjunction with the appended drawings, wherein like designations denote like elements.

### DETAILED DESCRIPTION

As discussed above, embodiments of the present invention relate to a fantasy sports trade debate system and more particularly to an internet-based fantasy sports community for providing user-generated fantasy sports input for fantasy team owners to better optimize and manage their fantasy team in a fantasy sports league.

A fantasy sports trade debate system comprises a user-generated website hosted on a secure computer network that may present advice, information, and analysis to fantasy sports players (managers.) The fantasy sports trade debate system may comprise a trade debate website where there may be different pages for all fantasy sports, such as football, baseball, basketball, hockey, and so forth. These pages may be driven by user-generated polls, rating systems, comments, and recommendations. The site may be socially-based, with the users providing notes, statistics, and trade variables by means of a specially designed Web Box, Light Box, or other commentary means.

Trade debate website users posting trades may be given a notes section in an easy-to-use commentary box where they may add any variables that other users may need to know about a specific trade in order to provide accurate an vote and commentary. The potential trade may then be published on a homepage of the trade debate website where other users may indicate who they favor in the trade through a polled vote. A comments section and an archive number may be attached to every trade. The owner who posted the trade may then make a decision based on the results of the poll after a user-defined timed window, as well as the comments from other users. A search engine may allow users to find their posted trade and any player ever involved in any posted trade throughout an entire fantasy sports season. An active ticker of successful trades made in fantasy leagues may scroll across the top screen as an indicator of a trade being posted, polled, commented, and completed. Furthermore, the trade debate website may utilize a continuous RSS feed with functionality around each trade that will make it easy to interact with by the user.

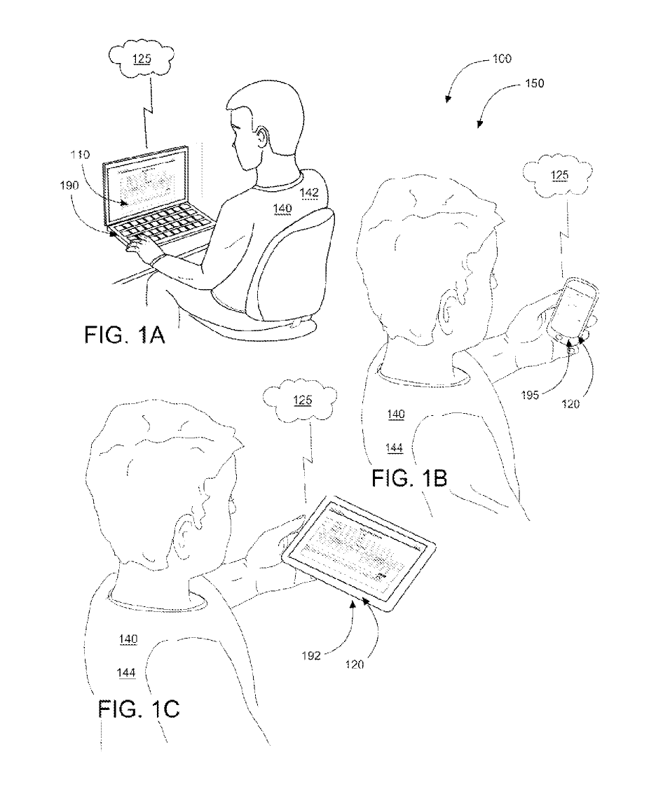

Referring to the drawings by numerals of reference there is shown in FIG. 1A, fantasy sports trade debate systems 100 (fantasy sports trade evaluation and advisory system) during ‘in-use’ condition 150.

As shown, fantasy sports trade debate systems 100 may comprise trade debate website 110 which may be accessible via internet 125 by user 140 who may be using a first inputting comprising communication device 120. User 140 may use communication device 120 comprising computer 190 to connect to internet 125, as shown in FIG. 1A. User 140 may comprise fantasy manager 142 who may be a manager/owner of a fantasy sports team hosted by a fantasy sports league. It should be noted that trade debate website 110 may cater to fantasy sports leagues of a variety of professional sports such as football, baseball, basketball, hockey, tennis, soccer, golf, and so on and so forth. Further, trade debate website 110 may cater to fantasy sports leagues within college sports and non-professional sports. By way of example, the illustrations and description herein refer to fantasy football correlating to players who play in the National Football League NFL®.

Referring now to FIG. 1B, illustrating fantasy sports trade debate systems 100 during ‘in-use’ condition 150. As shown, trade debate website 110 may be accessible by user 140 who may be using a second inputter comprising communication device 120 comprising smart phone 195 to connect to internet 125. User 140 may comprise fantasy advisor 144 who may vote, comment, and otherwise interact with fantasy manager 142 on trade debate website 110. It should be noted that user 140 comprising either fantasy manager 142 or fantasy advisor 144 may connect to trade debate website 110 using communication device 120 whereby communication device 120 may comprise any suitable mobile or electronic communication device comprising a connection to internet 125.

Referring now to FIG. 1C, illustrating fantasy sports trade debate systems 100 during ‘in-use’ condition 150. As shown, trade debate website 110 may be accessible by user 140 who may be using tablet 192. Tablet 192 may comprise iPad® or the like. In such a manner, user 140 comprising fantasy manager 142 or fantasy advisor 144 may access trade debate website 120 in a variety of environments and using a variety of communication devices 120. Communication device 120 may include, but is not limited to, computer 190, tablet 192 (such as iPad® or Kindle® or the like, smart phone 195, PDA, internet TV, gaming console, etc. It should be further noted that fantasy advisor 144 may comprise an anonymous user and need not register an account on trade debate website 110 to utilize trade debate website 110.

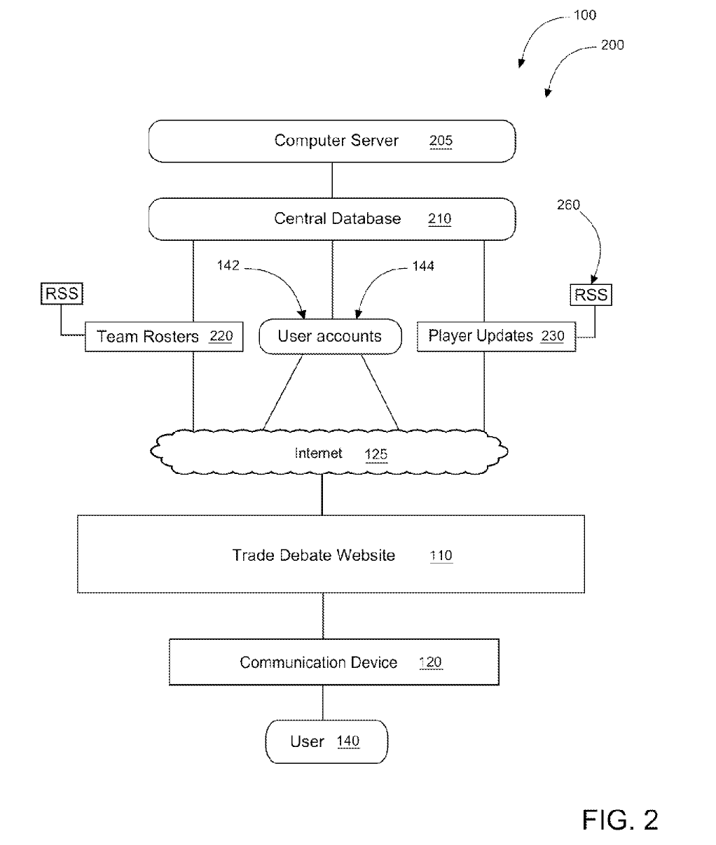

Referring now to FIG. 2, illustrating data flowchart 200 of fantasy sports trade debate systems 100 according to a preferred embodiment of the present invention. As shown, computer server 205 may comprise a secure computer network for storing central database 210. Central database 210 may comprise a MYSQL or comparable database for storing files, logs, and scripts of fantasy sports trade debate systems 100. Central database 210 may comprise team rosters 220 comprising a complete list of players who play on a plurality of sports teams having a fantasy sports league. Furthermore, central database 210 may comprise player updates 230 which may comprise a system for providing important updates of sports athletes, such as injury reports, trade reports, player suspensions, and the like.

Team rosters 220 and player updates 230 may be continuously updated within central database 210 via a RSS feed 260. RSS feed 260 (Rich Site Summary) may comprise a format for delivering regularly changing web content to trade debate website 110. In addition, central database 210 may comprise a plurality of user accounts. User accounts may be created freely by user 140 visiting trade debate website 110. The user account may comprise personal login information unique to user 140 and central database 210 may store information relevant to each unique user account, such as user profile information, contact information, and a history of past fantasy sports trades posted on trade debate website 110 along with comments that have been posted on trades published by other users 140. Central database 210 hosted by computer server 205 may be accessible via internet 125, as shown in FIG. 2. In such a manner, trade debate website 110 may be accessible via communication device 120 which may be used by user 140, as shown.

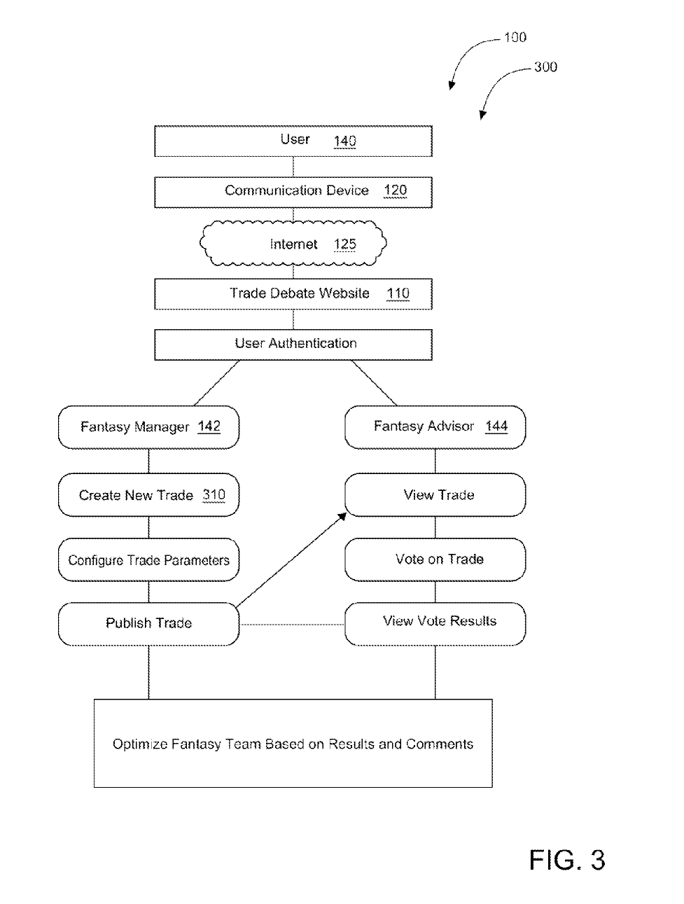

Referring now to FIG. 3, illustrating user flowchart 300 according to a preferred embodiment of fantasy sports trade debate systems 100.

As shown, user 140 may connect to trade debate website 110 over internet 125 via communication device 120. In one embodiment, user 140 may access trade debate website 110 by visiting http://www.tradedebate.com. Once user 140 arrives at trade debate website 110, user 140 may proceed through user authentication software installed on trade debate website 110 in order to log in. If user 140 is fantasy manager 142 of a fantasy sports team, user 140 may create trade 310. Fantasy manager 142 may configure parameters for trade 310 by entering information pertaining to the fantasy players to be traded along with notes or comments which may assist fantasy advisor 144 to vote and comment on trade 310. Once the parameters for trade 310 have been configured, fantasy manager 142 may publish trade 310 thereby making trade 310 viewable by other users 140 on trade debate website 110.

Once published, fantasy advisor 144 may view trade 310 up for consideration by fantasy manager 142 and may vote on trade 310 and/or optionally comment on trade 310. Once fantasy advisor 144 has voted on trade 310, fantasy advisor 144 may the overall voting results of trade 310. In such a manner, user 140 comprising fantasy advisor 144 has an incentive to vote on trade 310 in order to see the voting results as the voting results will not be viewable prior to submitting a voting response to trade 310. Both fantasy manager 142 and fantasy advisor 144 may use the voting results and comments provided by other users 140 responding to trade 310 in order to optimize a fantasy sports team.

It should be noted that trade debate website 110 may comprise at least one search engine. User 140 may perform a search of trade debate website 110 via the search engine. Preferably, user 140 may search for any individual player stored by central database 210 on computer server 205. When user 140 inputs a search query into the search engine for a specific player, the search engine may return results comprising any trade 310 posted to trade debate website 110 involving that particular player. Furthermore, user 140 may use the search engine to look up specific usernames of trade debate website 110 to view a history of trade(s) 310 published by that particular username. Additionally, user 140 may use the search engine to search for notes, updates, and announcements regarding a specific fantasy sports league.

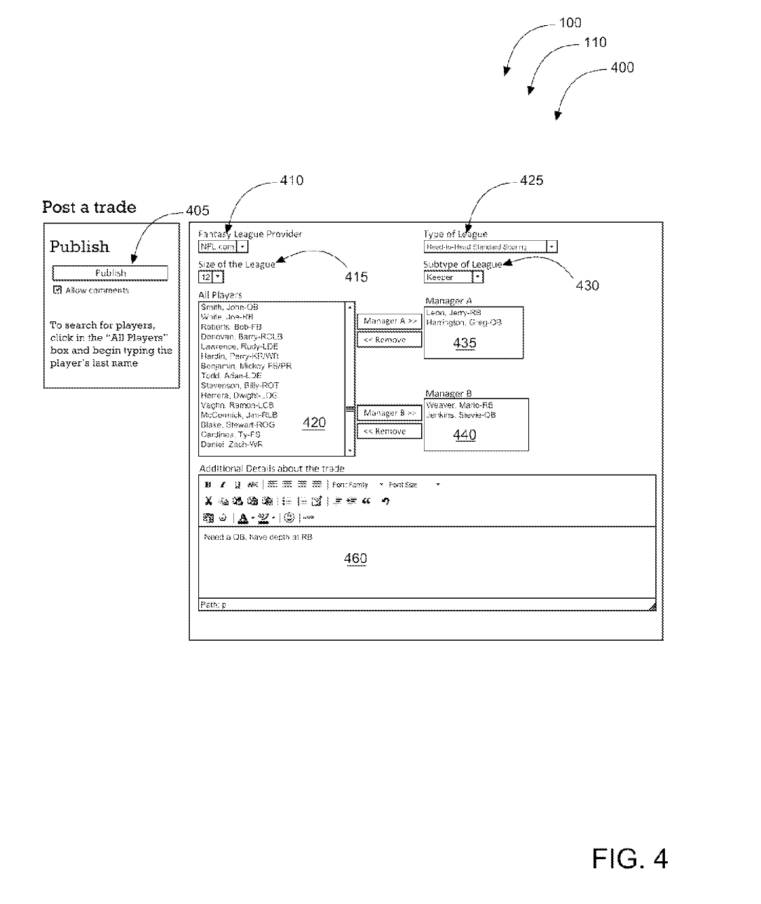

In turning now to FIG. 4, showing new trade creator screen 400 of trade debate website 110 according to an embodiment of fantasy sports trade debate systems 100. Fantasy manager 142 may select the type of fantasy league via league provider field 410. League provider field 410 may comprise any professional or non-professional sports league where a fantasy sports game may be played. Fantasy manager 142 may the amount of teams in the sports league via league size field 415. Once the fantasy league provider is selected, player bank field 420 may be populated with a full list of players who play within that sports league. Fantasy manager 142 may then select the type of fantasy league via league type field 425. League type field 425 may comprise head-to-head standard scoring, head-to-head point per reception, rotisserie, just to name a few. It should be appreciated that league type field 425 may comprise any type of fantasy sports league as played within fantasy sports. Fantasy manager 142 may then designate a subtype of fantasy league via league subtype field 430.

In continuing to refer to FIG. 4, once fantasy manager 142 configures the parameters of trade 310 via new trade creator screen 400, fantasy manager 142 may then select players from player bank field 420 involved in trade 310 between Manager A (fantasy manager 142) and Manager B (other fantasy team manager). To designate players involved in trade 310, fantasy manager 142 may select a player from player bank field 420 and then click “Manager A” button to add the player to manager A player area 435. Next, fantasy manager 142 may select a player from player bank field 420 and click “Manager B” button to add the player to manager B player area 440. It should be noted that fantasy manager 142 may select and add as many players as necessary that are involved in trade 310. It should further be noted that players may be removed from manager A player area 435 or manager B player area 440 by clicking “Remove” button, as shown in FIG. 4.

In still referring to FIG. 4, fantasy manager 142 may further add comments regarding trade 310 via comment box 460. Comment box 460 may comprise a user-editor box whereby fantasy manager 142 may submit user-preferred notes regarding specific information concerning trade 310 that may be relevant to fantasy advisor 144 voting on trade 310. For example, fantasy manager 142 may include an optional comment advising user(s) 140 on trade debate website 110 viewing trade 310 that Manager A has a lot of players occupying a specific position or that Manager B is vying for a final playoff spot in his/her fantasy league. The comments that may be added are limited to one's imagination. Once all parameters are configured on new trade creator screen 400, fantasy manager may click publish button 405 in order to publish trade 310 to trade debate website 110. It should be noted that at any time, fantasy manager 142 may edit trade 310 as needed. In a preferred embodiment of fantasy sports trade debate systems 100, trade 310 published by fantasy manager 142 appears as a clickable link on the homepage of trade debate website 110. Further, trade 310 may be viewable via RSS feed 260 which may be seen on multiple pages within trade debate website 110.

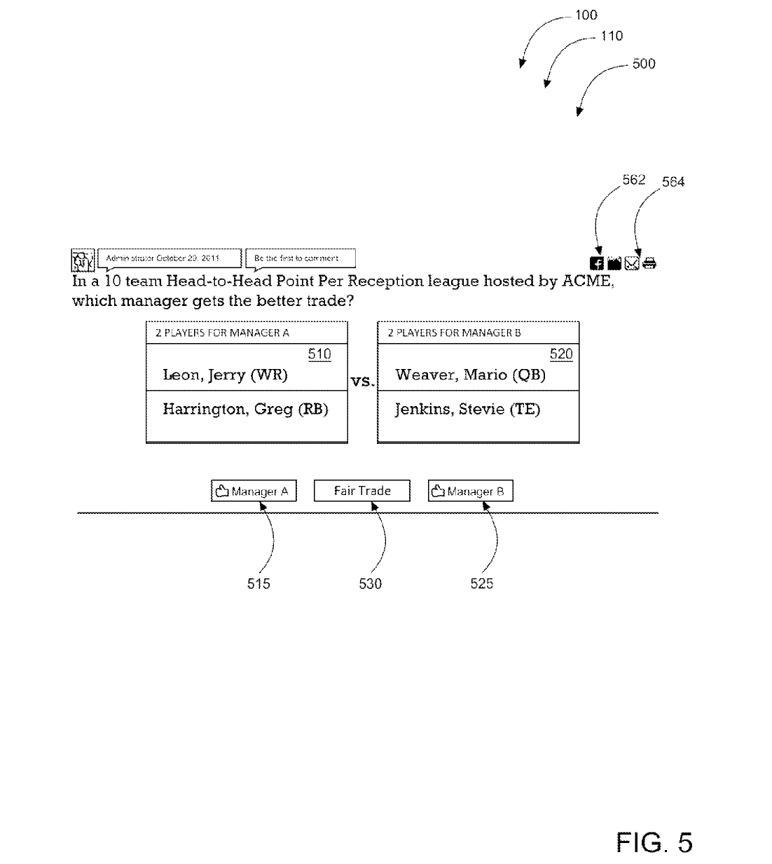

In referring now to FIG. 5, illustrating trade vote screen 500 of trade debate website 110 according to an embodiment of fantasy sports trade debate systems 100. User 140 of trade debate website 310 comprising fantasy advisor 144 may view trade 310 created and published by fantasy manager 142 on trade vote screen 500. Fantasy advisor 144 may view the players that Manager A will receive in trade 310 in manager A receiving players area 510 and may view the players that Manager B will receive in trade 310 in manager B receiving players area 520. Should fantasy advisor 144 believe that Manager A is receiving the better deal in trade 310, fantasy advisor 144 may click Manager A vote button 515 to vote for Manager A. Should fantasy advisor 144 believe that Manager B is receiving the better deal in trade 310, fantasy advisor 144 may click Manager B vote button 525 to vote for Manager B. Should fantasy advisor 144 believe that trade 310 is fair and that neither manager is receiving a better deal, fantasy advisor 144 may click fair trade vote button 530.

In continuing to refer to FIG. 5, trade vote screen 500 of trade debate website 110 may comprise social media icons 562 located toward a top area of trade vote screen 500. Social media icons 562 may comprise clickable icons to popular social media websites such as Facebook®, Twitter®, Linkdin®, and other social media websites. In such a manner, fantasy advisor 144 may share trade 310 with friends, family, and others who may be interested in participating in voting on trade 310. Furthermore, trade vote screen 500 may comprise share and print icons 564. Share and print icons 564 may comprise an icon for printing trade 310 and for sharing trade 310 via email with others. Share and print icons 564 may provide fantasy manager 142 and fantasy advisor 144 with an easy and convenient manner to reproduce trade vote screen 500 and to share trade 310 with other fantasy sports players.

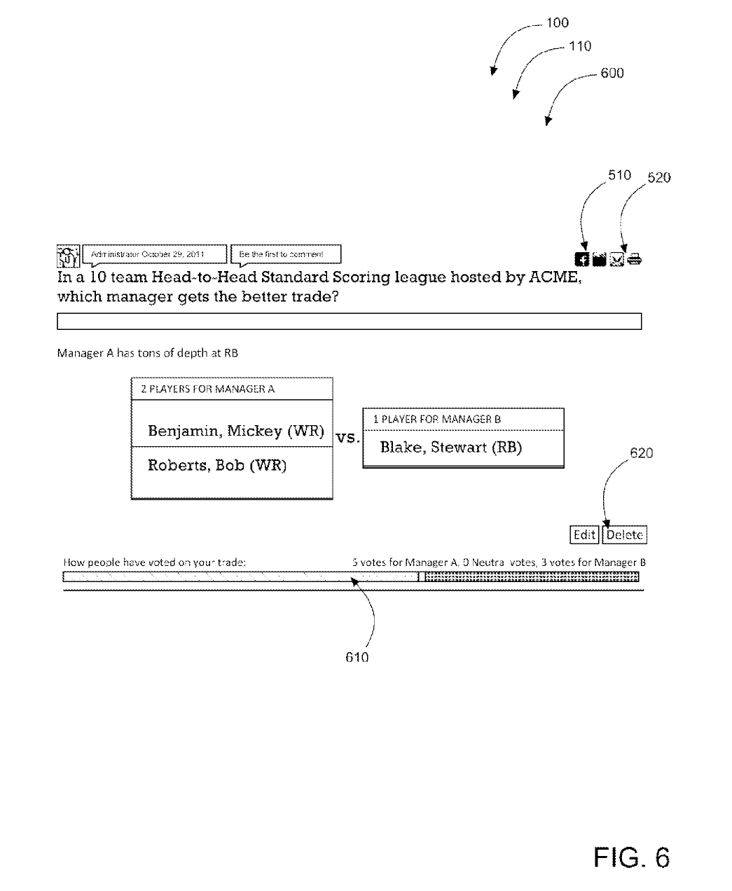

Referring now to FIG. 6, illustrating vote results screen 600 of trade debate website 110 according to an embodiment of fantasy sports trade debate systems 100. Once fantasy advisor 144 votes on trade 310 created by fantasy manager 142, fantasy advisor 144 may see vote results via vote results graph 610. In one embodiment, vote results graph 610 may comprise a colored, horizontal bar chart to visually display whether Manager A or Manager B received more votes. Above vote results graph 610, statistics may appear which may show exactly how many votes were placed for Manager A, how many votes were placed for Manager B, and how many votes were neutral indicating a fair and even trade 310.

In still referring to FIG. 6, vote results screen 600 may comprise trade modification buttons 620 which may be available to fantasy manger 142 who created trade 310. As shown, trade modification buttons 620 may comprise a clickable button entitled “Edit” and a clickable button entitled “Delete”. When fantasy manager 142 who created trade 310 clicks on the “Edit” button, fantasy manager 142 may modify trade 310 to reflect new players or comments. Frequently in fantasy sports, fantasy managers involved in trade 310 may make counter-offers modifying athletes involved in trade 310. In such a manner, fantasy manager 142 may easily update and modify trade 310 in accordance with any counter-offers between fantasy managers. Once trade 310 has been edited by fantasy manager 142, the voting statistics may reset to 0. When fantasy manager 142 who created trade 310 clicks on the “Delete” button, the option to vote on trade 310 may be removed from trade vote screen 500. This may be done to indicate that trade 310 between Manager A and Manager B has been accepted, rejected, or withdrawn. Additionally, vote results screen 600 may also comprise social media icons 562 and share and print icons 564 for sharing and printing vote results screen 600.

In one embodiment of fantasy sports trade debate systems 100, trade debate website 110 may comprise a permanent navigational and RSS feed toolbar. The permanent navigational and RSS feed toolbar may appear at either a top portion of trade debate website 110 or a bottom portion of trade debate website 110 and may remain stationary despite any scrolling performed by user 140. The permanent navigational and RSS feed toolbar may comprise a live syndicate feed of newly published trade(s) 310, fantasy sports announcements and updates, and the like. Because the permanent navigational and RSS feed toolbar is stationary, user 140 of trade debate website 110 will be able to constantly see new trades 310 being published by fantasy manager 142 or voted on by fantasy advisor 144. This may enable user 140 to be kept updated in real-time and may provide a more enjoyable website surfing experience of fantasy sports trade debate systems 100.

The present invention, an interactive fantasy sports trade debate system 100 in preferred embodiments comprises; at least one central database 210, wherein central database 210 is in communication with trade debate website 110; at least one computer server 205, wherein computer server 205 securely hosts central database 210, and central database 210 hosts trade debate website 110; at least one internet 125 system; at least one first inputter comprising first communication device 120, whereby first communication device 120 comprises a connection to internet 125 for use by fantasy manager 144.

The system further comprises at least one second inputter comprising second communication device 120, whereby second communication device 120 comprises a connection to internet 125 for use by fantasy advisor 144. Central database 210 may comprise fantasy sports data, whereby fantasy sports data comprises sports team rosters 220, and whereby sports team rosters 220 comprises a roster of players involved in a sports league that is played live. The sports league may comprise a professional sporting league.

Preferably, the fantasy sports data is stored on central database 210 hosted on computer server 205, and central database 210 is accessible to fantasy manager 142 and fantasy advisor 144 via trade debate website 110. Fantasy manager 142 may input a viewable transaction comprising trade 310 via the first inputter comprising communication device 120, and fantasy advisor 144 is able to view trade 310 via the second inputter also comprising communication device 120. Both fantasy manager 142 and fantasy advisor 144 are able to actively scrutinize trade 310 and input an opinion via communication device 120; and both fantasy manager 142 and fantasy advisor 144 are able to use the opinion(s) to optimize a fantasy sports team.

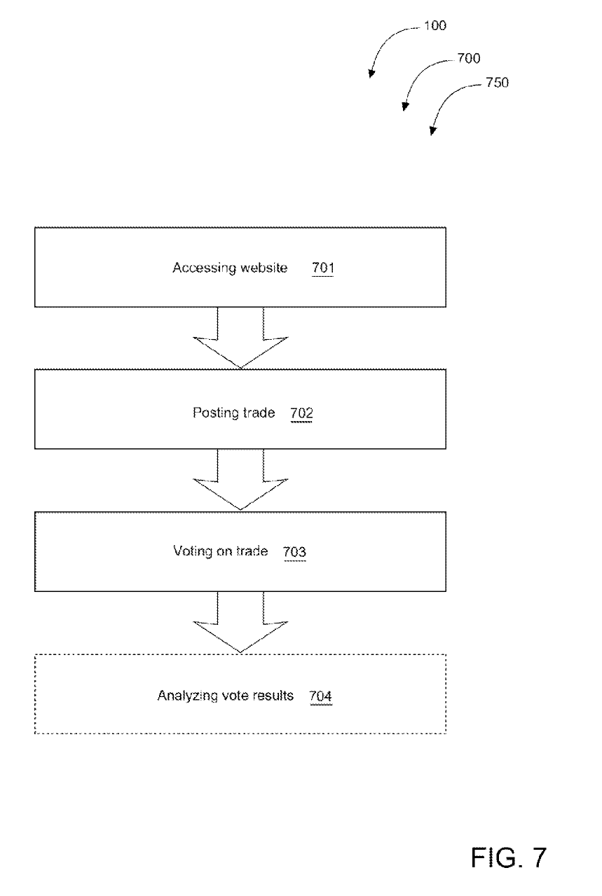

FIG. 7 is a flowchart 750 illustrating a method of use 700 for fantasy sports trade debate systems 100 according to an embodiment of the present invention of FIGS. 1-6.

A method of using (method of use 700) trade debate website 110 comprises the steps of: step one 701 accessing trade debate website 110 via communication device 120, step two 702 posting trade 310 by fantasy manager 142 on trade debate website 110, step three 703 voting on trade 703 by fantasy advisor 144 (or fantasy manager 142), and step four 704 analyzing vote results to optimize a fantasy sports team.

It should be noted that step four 704 is an optional step and may not be implemented in all cases. Optional steps of method 700 are illustrated using dotted lines in FIG. 7 so as to distinguish them from the other steps of method 700.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended

1. An interactive fantasy sports trade evaluation and advisory system comprising;
at least one central database;
at least one computer server;
at least one internet system;
at least one first inputter for use by a fantasy manager; and
at least one second inputter for use by a fantasy advisor;
wherein said at least one central database comprises fantasy sports data;
wherein said at least one central database comprising said fantasy sports data is hosted on said at least one computer server;
wherein said at least one central database hosted on said at least one computer server is accessible to said fantasy manager and said fantasy advisor via said at least one internet system;
wherein said fantasy manager inputs a viewable transaction via said first inputter;
wherein said fantasy adviser is able to view said viewable transaction;
wherein said fantasy adviser is able to actively scrutinize said viewable transaction and input an opinion via said second inputter;
wherein said fantasy manager is able to view said opinion of said fantasy advisor to assess said viewable transaction; and
wherein said fantasy manager is able to use said opinion(s) to optimize said fantasy sports team.

2. The interactive fantasy sports trade evaluation and advisory system of claim 1, wherein a website is in communication with said central database, said website hosted on said central server.

3. The interactive fantasy sports trade evaluation and advisory system of claim 1, wherein said fantasy sports data comprises a roster of players.

4. The interactive fantasy sports trade evaluation and advisory system of claim 3, wherein said roster comprises said players, said players involved in a sports league that is played live.

5. The interactive fantasy sports trade evaluation and advisory system of claim 4, wherein a performance of said players involved in said sports league that is played live equates to a point value in a fantasy sports league.

6. The interactive fantasy sports trade evaluation and advisory system of claim 5, wherein said viewable transaction comprises a trade of said players between said fantasy manager and a second fantasy manager in said fantasy sport league.

7. The interactive fantasy sports trade evaluation and advisory system of claim 6, wherein said trade is able to be voted on by said fantasy advisor such that said fantasy manager is able to view said vote provided by said fantasy advisor.

8. The interactive fantasy sports trade evaluation and advisory system of claim 6, wherein said trade is able to be actively scrutinized by said fantasy advisor such that said fantasy manager is able to view comments provided by said fantasy advisor.

9. The interactive fantasy sports trade evaluation and advisory system of claim 2, wherein said fantasy advisor is an anonymous internet user of said website.

10. The interactive fantasy sports trade evaluation and advisory system of claim 1, wherein said first inputter or said second inputter comprises a computer.

11. The interactive fantasy sports trade evaluation and advisory system of claim 1, wherein said first inputter or said second inputter comprises a tablet.

12. The interactive fantasy sports trade evaluation and advisory system of claim 1, wherein said first inputter or said second inputter comprises a smart phone.

13. The interactive fantasy sports trade evaluation and advisory system of claim 2, wherein said website comprises a user database.

14. The interactive fantasy sports trade evaluation and advisory system of claim 13, wherein said user database enables said fantasy manager and said fantasy adviser to create a user account on said website, said user account capable of storing user-created profile, said user-created profile publicly viewable on said website.

15. The interactive fantasy sports trade evaluation and advisory system of claim 2, wherein said website comprises a search engine.

16. The interactive fantasy sports trade evaluation and advisory system of claim 2, wherein said website comprises an RSS feed for syndicating said viewable transactions automatically on a homepage of said website.

17. The interactive fantasy sports trade evaluation and advisory system of claim 4, wherein said sports league comprises a professional sporting league.

18. The interactive fantasy sports trade evaluation and advisory system of claim 4, wherein said sports league comprises a non-professional sporting league.

19. An interactive fantasy sports trade evaluation and advisory system comprising;
at least one central database, said central database in communication with a website;
at least one computer server, said computer server hosting said central database, said central database further hosting said website;
at least one internet system;
at least one first inputter comprising a first electronic communication device, said first electronic communication device comprising a connection to said internet system for use by a fantasy manager; and
at least one second inputter comprising a second electronic communication device, said second electronic communication device comprising another connection to said internet system for use by a fantasy advisor;
wherein said at least one central database comprises fantasy sports data, said fantasy sports data comprising a roster of players, said roster of players involved in a sports league that is played live, said sports league comprising a professional sporting league;
wherein said at least one central database comprising said fantasy sports data is hosted on said at least one computer server;
wherein said at least one central database hosted on said at least one computer server is accessible to said fantasy manager and said fantasy advisor via said at least one internet system;
wherein said fantasy manager inputs a viewable transaction via said first inputter, said viewable transaction comprising a trade;
wherein said fantasy adviser is able to view said viewable transaction;
wherein said fantasy adviser is able to actively scrutinize said viewable transaction and input an opinion via said second inputter;
wherein said fantasy manager is able to view said opinion of said fantasy advisor to assess said viewable transaction; and
wherein said fantasy manager is able to use said opinion(s) to optimize said fantasy sports team.

20. A method of using an interactive fantasy sports trade evaluation and advisory system comprising the steps of:
accessing a website hosted on a computer server;
posting a trade on said website by a fantasy manager;
voting on said trade on said website by a fantasy adviser; and
analyzing results of said voting to optimize a fantasy sports team.
